(19) United States
(12) Patent Application Publication
(10) Pub. No.: US 2026/0094585 A1
(43) Pub. Date: Apr. 2, 2026

(54) PERFORMANCE SOUND GENERATION METHOD, PERFORMANCE SOUND GENERATION DEVICE, AND NON-TRANSITORY COMPUTER-READABLE STORAGE MEDIUM STORING PERFORMANCE SOUND GENERATION PROGRAM

(71) Applicant: Yamaha Corporation, Hamamatsu (JP)

(72) Inventors: Shigeru KAI, Yokohama (JP); Yoshinari NAKAMURA, Hamamatsu (JP); Akio OHTANI, Tokyo (JP); Daichi ISERI, Fukuroi (JP); Takuya FUJISHIMA, Hamamatsu (JP); Ryo MATSUDA, Hamamatsu (JP); Hayato YAMAKAWA, Hamamatsu (JP); Akihiko SUYAMA, Hamamatsu (JP); Ryota MITSUOKA, Kawasaki (JP); Takahiro HARA, Hamamatsu (JP); Hirokazu SUZUKI, Yokohama (JP); Shuntaro SUZUKI, Shizuoka (JP)

(21) Appl. No.: 19/411,111

(22) Filed: Dec. 5, 2025

Related U.S. Application Data
(63) Continuation of application No. PCT/JP2024/018656, filed on May 21, 2024.

(30) Foreign Application Priority Data
Jun. 6, 2023 (JP) 2023-093238

(51) Int. Cl. G10H 1/00; G06Q 30/018; G06T 17/00

(52) U.S. Cl. CPC G10H 1/0008; G06T 17/00; G10H 1/0033; G06Q 30/0185; G10H 2220/455; G10H 2240/171

(57) ABSTRACT

A performance sound generation method includes acquiring image information of a first instrument and acoustic information of the first instrument that changes in accordance with an environment change of the first instrument, acquiring performance operation information of a user, rendering an image of the first instrument based on the image information, and generating a performance sound of the first instrument based on the performance operation information and the acoustic information.

### CROSS-REFERENCE TO RELATED APPLICATIONS

This application is a continuation application of International Application No. PCT/JP2024/018656, filed on May 21, 2024, which claims priority to Japanese Patent Application No. 2023-093238 filed in Japan on Jun. 6, 2023. The entire disclosures of Japanese Patent Application No. 2023-093238 are hereby incorporated herein by reference.

### BACKGROUND

### Technical Field

One embodiment of this disclosure generally relates to a performance sound generation method, a performance sound generation device, and a non-transitory computer-readable storage medium storing performance sound generation program.

### Background Information

A musical instrument 100 of Japanese Laid Open Patent Application No. 2014-228750 comprises an operating unit 110 that receives a performance operation, a generation unit 120 that generates performance information representing the received performance operation, a detection unit 130 that detects a mobile terminal, and a control unit 170 that, when the mobile terminal is detected, records, in the musical instrument and/or the mobile terminal, the performance information generated by the generation unit and/or a video capturing a scene in which the performance operation is being carried out.

A piano of Japanese Laid Open Patent Application No. 2014-228751 generates performance information indicating a performance operation that has been received, and, if a pedal is not depressed in the performance operation and the generated musical sound is a single tone, detects the sound generation state (for example, musical sound waveform data) of said single tone. At this time, so as not to be affected by the musical sound immediately before the single tone, the piano detects the sound generation state of the single tone after a prescribed period of time has elapsed from the end time point of the performance operation for generating said musical sound. The piano transmits and outputs, to a server device, log data including the performance information and sound generation detection data indicating the detected sound generation state. The server device analyzes the log data collected from the piano and generates, and outputs to the piano, notification information for issuing a notification relating to the state of the piano (for example, notification of whether tuning is necessary or the recommended timing of tuning).

The piano 10 of Japanese Laid Open Patent Application No. 2014-228752 detects key information using a key sensor 151, detects pedal information using a pedal sensor 152, detects hammer information using a hammer sensor 153, detects plunger speed information using a plunger speed sensor 154, detects position information of the piano 10 using a GPS sensor 155, detects tilt information of the piano 10 using a tilt sensor 156, detects ambient temperature information using an ambient temperature sensor 157, detects ambient humidity information using an ambient humidity sensor 158, detects plunger temperature information using a plunger temperature sensor 159, and transmits log data containing these detection data to a server device. The server device analyzes the log data and generates, and transmits to the piano 10, notification information for notifying the state of the piano 10 (for example, notification of whether tuning is necessary or the recommended timing of tuning).

### SUMMARY

An object of one aspect of the present disclosure is to provide a performance sound generation method that allows a user to perceive as if the user is playing a musical instrument in any environment.

A performance sound generation method according to one embodiment of this disclosure comprises acquiring image information of a first instrument and acoustic information that changes in accordance with an environment change of the first instrument, acquiring performance operation information of a user, rendering an image of the first instrument based on the image information, and generating a performance sound of the first instrument based on the performance operation information and the acoustic information.

### BRIEF DESCRIPTION OF THE DRAWINGS

FIG. 1 is a configuration diagram of a performance sound generation system.

FIG. 2 is a block diagram showing a configuration of a PC 1.

FIG. 3 is a flowchart showing an operation of a performance sound generation method according to the present embodiment.

FIG. 4 is a configuration diagram of a performance sound generation system according to a second modified example.

FIG. 5 is a configuration diagram of a performance sound generation system according to a third modified example.

FIG. 6 is a configuration diagram of a performance sound generation system according to a fifth modified example.

FIG. 7 is a configuration diagram of a performance sound generation system according to a sixth modified example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

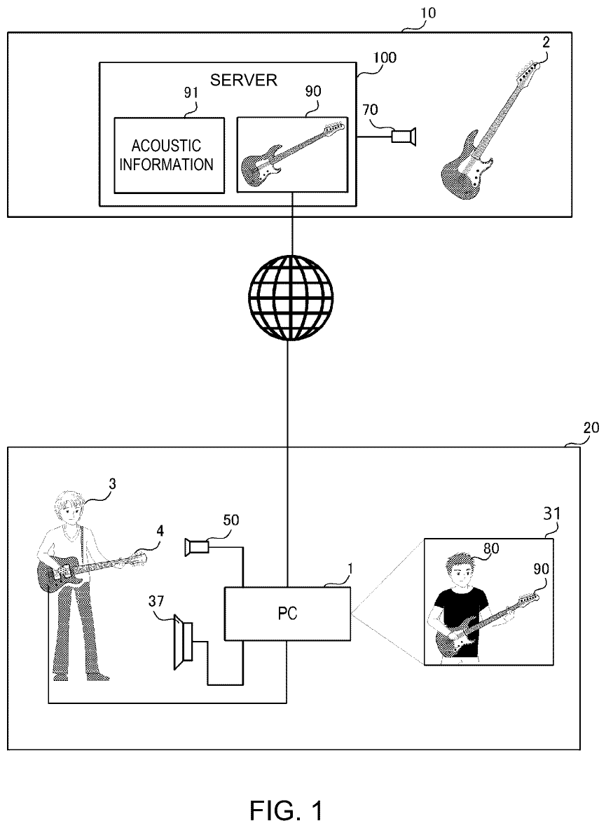

FIG. 1 is a configuration diagram of a performance sound generation system according to the present embodiment. The performance sound generation system of the present embodiment comprises a server 100 installed at a first location 10 and a PC 1 installed at a second location 20. The first location 10 is a musical instrument store, for example. The first location 10 is provided with a first instrument 2 for sale. The second location 20 is the home of a first performer 3, who is a user.

The first performer 3 at the second location 20 connects a second instrument 4 to the PC 1. As an example, in the present embodiment, the first instrument 2 and the second instrument 4 are electric guitars. In the present embodiment, a “performance” is not limited to playing a musical instrument, but also includes singing using a microphone.

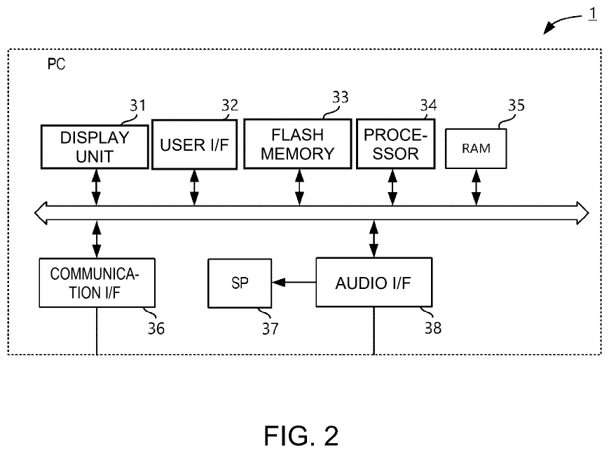

FIG. 2 is a block diagram showing a configuration of the PC 1. In the present embodiment, the PC 1 is one example of a performance sound generation device and information processing device.

The PC 1 comprises a display unit 31, a user I/F 32, a flash memory 33, a processor 34, RAM 35, a communication I/F 36, a speaker (SP) 37, and an audio I/F 38.

The display unit 31 is a display including an LED (light-emitting diode), an LCD (liquid-crystal display), or an OLED (organic light-emitting diode), for example, and displays various information. The user I/F (interface) 32 is a touch panel stacked on the LCD or the OLED of the display unit 31. Alternatively, the user I/F 32 can be a user operable input such as a keyboard, a mouse, or the like. When the user I/F 32 is a touch panel, the user I/F 32 constitutes a graphic user interface (GUI), together with the display unit 31.

The communication I/F (interface) 36 includes a network interface and is connected to a network such as the Internet via a router (not shown). In addition, the communication I/F 36 is connected to a camera 50 as illustrated in FIG. 1.

The camera 50 acquires image signal(s) of the first performer 3 and the second instrument 4. The processor 34 applies signal processing to the image signal(s) received from the camera 50.

The audio I/F (interface) 38 has an analog audio terminal. The audio I/F 38 is connected to a musical instrument or an audio device such as a microphone via an audio cable and receives analog sound signals. In the present embodiment, the audio I/F 38 of the PC 1 is connected to the second instrument 4 and receives analog sound signals relating to performance sounds from the second instrument 4. The audio I/F 38 converts the received analog sound signals into a digital sound signals. In addition, the audio I/F 38 converts digital sound signals into analog sound signals. The SP 37 reproduces sounds based on the analog sound signals.

The processor 34 includes a CPU (Central Processing Unit), DSP (Digital Signal Processor), SoC (system-on-a-chip), or the like, and reads, into the RAM 35, a program stored in the flash memory 33, which is a storage medium, to control each component of the PC 1. The processor 34 is one example included in an electronic controller of the PC 1, and the electronic controller can be configured to comprise one or more processors. Here, the term “electronic controller” as used herein refers to hardware, and does not include a human. The flash memory 33 stores the program of the present embodiment. A computer memory such as flash memory 33 is one example of a non-transitory computer-readable medium.

The processor 34 applies signal processing to digital sound signals received from the audio I/F 38. The processor 34 outputs, to the audio I/F 38, the digital sound signals that have been subjected to signal processing. The audio I/F 38 converts the digital sound signals that have been subjected to signal processing into analog sound signals.

The SP 37 reproduces the analog sound signals output from the audio I/F 38 to reproduce sounds of the second instrument 4.

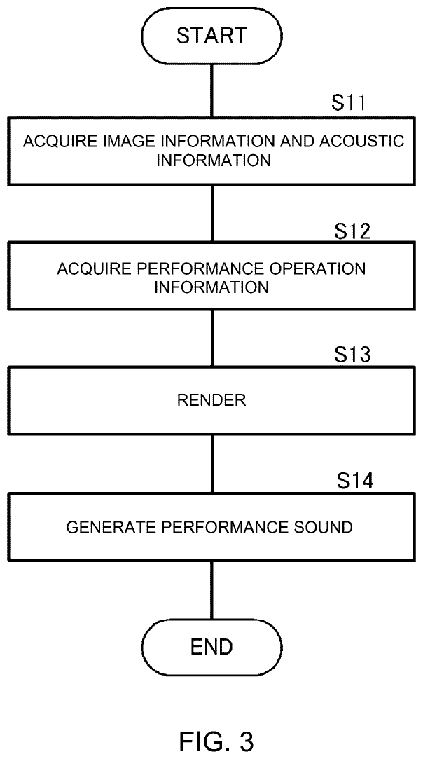

The processor 34 of the PC 1 executes the performance sound generation method of the present embodiment. FIG. 3 is a flowchart showing an operation of the performance sound generation method according to the present embodiment.

The processor 34 first acquires image information of the first instrument 2 and acoustic information of the first instrument 2 (S11). Specifically, the processor 34 receives, from the server 100, image information 90 and acoustic information 91 of the first instrument 2.

The image information 90 is 3D model data of the first instrument 2. The model data of the first instrument 2 include, for example, a plurality of pieces of polygon data and bone data for configuring the body, neck, strings, and the like, of the first instrument 2. The plurality of pieces of bone data constituting the model data of the first instrument 2 can have a linked structure connected by a plurality of pieces of joint data. In particular, in the case of an instrument with a range of motion, the model data preferably include a linked structure. In addition, the image information 90 is not limited to 3D model data. The image information 90 can be 2D image data. In addition, the image information 90 is not limited to still images and can be moving images.

Such image information 90 is acquired by a camera 70, which is an example of a sensor connected to the server 100. The 3D model data of the first instrument 2 are created in advance, but the camera 70 acquires an exterior image of the first instrument 2 at the current point in time. The server 100 adjusts the pre-created 3D model data based on the current exterior image of the first instrument 2 acquired by the camera 70. For example, the server 100 reflects changes in color, changes in surface reflectivity of metal parts, etc., caused by aging. Alternatively, the server 100 can reflect differences in the external appearance between day and night within one day. The server 100 recognizes the first instrument 2 from the exterior image of the first instrument 2 acquired by the camera 70, and identifies identification information of the first instrument 2, such as the type and product name. The server 100 prepares, in advance, a database in which exterior images of a large number of musical instruments are associated with identification information of the musical instruments, and acquires, using an exterior image of the first instrument 2 captured by the camera 70, the identification information of the corresponding first instrument 2. In addition, for example, the server 100 can prepare a trained model that has been trained on the relationship between exterior images of the first instrument 2 and the identification information using DNN (Deep Neural Network), etc., and input the exterior image into the trained model to acquire the identification information. In this case, for example, the server 100 acquires, in the training stage, a large number of datasets of exterior images of musical instruments and identification information. The server 100 trains a prescribed model on the relationship between exterior images and identification information based on the acquired exterior images and identification information. In the execution stage, the server 100 inputs the exterior image of the first instrument 2 received from the camera 70 into the trained model to acquire the identification information. As a result, the server 100 can, in S11, determine the image information 90 and the acoustic information 91 of the first instrument 2 and transmit the information to the PC 1.

The acoustic information 91 includes data that model the sound of the first instrument 2 as a digital sound source. The sound of the first instrument 2 changes in accordance with one or more environmental changes. For example, the properties of wood, which is the main material in a guitar body, change over time. In addition, magnets, used in pickups, also change over time. The sound of the first instrument 2 changes over time. In addition, the sound of the first instrument 2 also changes due to temperature, humidity, etc., of the storage environment. The acoustic information 91 includes not only data that model the sound when the product is new but also data that model the sound that has changed in accordance with the environmental changes, and changes over time.

In the process of S11, the processor 34 can receive, from the first performer 3, from which time point (for example, the present, one year ago, three years ago, etc.) the image information 90 or the acoustic information 91 is to be acquired. The processor 34 acquires, from the server 100, the image information 90 or the acoustic information 91 corresponding to the time point that is received.

In addition, the acoustic information 91 can include information relating to the reproduction environment. Information relating to the reproduction environment includes, for example, information relating to an audio device (effector, amplifier, speaker, etc.) that is connected to the first instrument 2, and information relating to the acoustics of the reproduction space. The sound of the first instrument 2 also changes depending on the acoustics of the reproduction space and the audio device that is connected. For example, the sound of the first instrument 2 varies between a studio environment such as an audition room, a concert hall, outdoors, and the like. The acoustic information 91 can include information relating to such various reproduction environments.

Subsequently, the processor 34 acquires performance operation information of the first performer 3 (S12). For example, in the case of a guitar, performance operation information is information indicating which fret is being pressed, the timing at which the fret is pressed, the timing at which the fret is released, information indicating which string is picked, the timing of picking, the speed of picking, the presence/absence of a mute operation, and the like. In addition, in the case of a keyboard instrument such as a synthesizer, performance operation information is pitch (note number), timbre, time parameters such as attack, decay, sustain, and release, and the like.

In the present embodiment, the performance operation information is acquired through the performance operation of the first performer 3 on the second instrument 4

The processor 34 acquires the performance operation information based on an image signal from the camera 50. Alternatively, the processor 34 can acquire motion data of the performer using a motion sensor, for example, to acquire the performance operation information.

In addition, the processor 34 can also acquire operation information of a musical instrument from a sensor mounted on the musical instrument. For example, in the case of a guitar, a sensor mounted on the musical instrument is a fret sensor attached to each fret. The processor 34 acquires the sensor signals for each fret to acquire the operation information of the musical instrument. Alternatively, in the case of an electronic instrument in which the strings to be picked have be replaced with sensors, the processor 34 acquires sensor signals to acquire the operation information of the musical instrument.

In addition, the processor 34 can extract features of a digital sound signal (sound signal of the second instrument 4) received from the audio I/F 38 and compare the features with features corresponding to operation information detected in advance, to acquire the performance operation information. In addition, for example, the processor 34 can prepare a trained model that has been trained on the relationship between sound signals and performance operation information using DNN, etc., and input the sound signal into the trained model to acquire the performance operation information. The processor 34 acquires, in the training stage, a dataset of sound signals and performance operation information from a server, or the like. Alternatively, the processor 34 can acquire, in the training stage, sensor signals for each fret to acquire the performance operation information, and acquire the sound signal received at that timing. The processor 34 trains a prescribed model on the relationship between sound signals and performance operation information based on the acquired sound signal and the performance operation information. In the execution stage, the processor 34 inputs the sound signal received from the second instrument 4 into the trained model and acquires the performance operation information.

Then, the processor 34 renders an image of the first instrument 2 based on the image information 90 (S13). More specifically, the processor 34 control the 3D model data of the first instrument 2 included in the image information 90, by using the performance operation information. In addition, the processor 34 can control 3D model data of a certain performer 80. The model data of the performer 80 include a plurality of pieces of polygon data and bone data for constructing, for example, the performer's face, torso, arms, fingers, and legs. The plurality of pieces of bone data have a linked structure, connected by a plurality of pieces of joint data. Position information of each piece of bone data of the model data is defined by motion data. The processor 34 controls the position information of the model data of the performer 80 based on the performance operation information of the performer. The processor 34 renders the 3D model data of the performer 80 and controls the position information of the 3D model data based on the performance operation information. The processor 34 displays, on the display unit 31, images (an image of the performer 80 and an image of the first instrument 2 included in the image information 90) relating to the rendered 3D model data.

Then, the processor 34 generates the performance sound of the first instrument 2 based on the performance operation information and the acoustic information 91 (S14). The performance operation information corresponds to parameters for synthesizing the sound of the sound source of the acoustic information 91. The processor 34 synthesizes the sound of the sound source (the guitar sound source of the first instrument 2 in the present embodiment) based on the performance operation information of the first performer 3.

The processor 34 can apply signal processing based on information relating to the reproduction environment included in the acoustic information 91. For example, when information relating to acoustics is included in the acoustic information 91, the processor 34 can carry out signal processing to convolve impulse response data of the reproduction environment onto the sound signal of the synthesized sound as a processing for reproducing the acoustics of the reproduction environment. In addition, the processor 34 can apply filter processing that simulates an audio device (effector, amplifier, speaker, etc.) that is connected to the first instrument 2 to the sound signal of the synthesized sound. Specifically, the information relating to the reproduction environment includes parameters of a digital signal processing block that simulates, as a digital filter, the output characteristics relative to the input of each audio device connected to the first instrument 2. The processor 34 applies signal processing to the sound signal of the synthesized sound, using parameters indicated by the information relating to the audio device. As a result, the processor can reproduce the input/output characteristics of the audio device (effector, amplifier, speaker, etc.) connected to the first instrument 2 with respect to the synthesized sound.

The processor 34 outputs the generated sound signal relating to the performance sound of the first instrument 2 to the SP (speaker) 37 via the audio I/F 38. As a result, the performance sounds of the first instrument 2 are reproduced in response to a performance operation of the first performer 3 on the second instrument 4. It should be noted that the server 100 can execute the operations shown in S13 and S14 of FIG. 3, and transmit, to the PC 1, the images and sound signals generated in S13 and S14. In this case, the PC 1 receives images and sound signals from the server 100 via a network, and reproduces the received performance sounds of the first instrument 2 in response to a performance operation of the user on the second instrument 4.

In this manner, the first performer 3 can use their own second instrument 4 at home to try out the first instrument 2 located at a store and listen to the performance sounds of the first instrument 2 without leaving home. A user of the performance sound generation method according to the present embodiment can have a customer experience of being able to perceive as if the user is playing a favorite musical instrument other than the second instrument 4 that the user is actually touching. More specifically, a user of the performance sound generation method according to the present embodiment can have a customer experience of being able to play a favorite musical instrument even from a remote location.

### FIRST MODIFIED EXAMPLE

A performance sound generation system according to a first modified example records, in a ledger on the Internet, a non-fungible token (hereinafter referred to as NFT) corresponding to the image information 90 and the acoustic information 91.

For example, a musical instrument store, which is the first location 10 in FIG. 1, records, in a digital ledger, an NFT corresponding to the image information 90 and the acoustic information 91 of the first instrument 2, which is a vintage item. As a result, the musical instrument store can authenticate by the NFT and link information relating to external appearances and information relating to sounds of musical instruments that are on sale. For example, the musical instrument store can sell the image information 90 and the acoustic information 91 of the first instrument 2, which is a vintage item authenticated by the NFT, and receive payment. The musical instrument store can set a free trial period to provide the image information 90 and the acoustic information 91 that are not NFT-authenticated, and provide NFT-authenticated image information 90 and acoustic information 91 after receiving payment.

### SECOND MODIFIED EXAMPLE

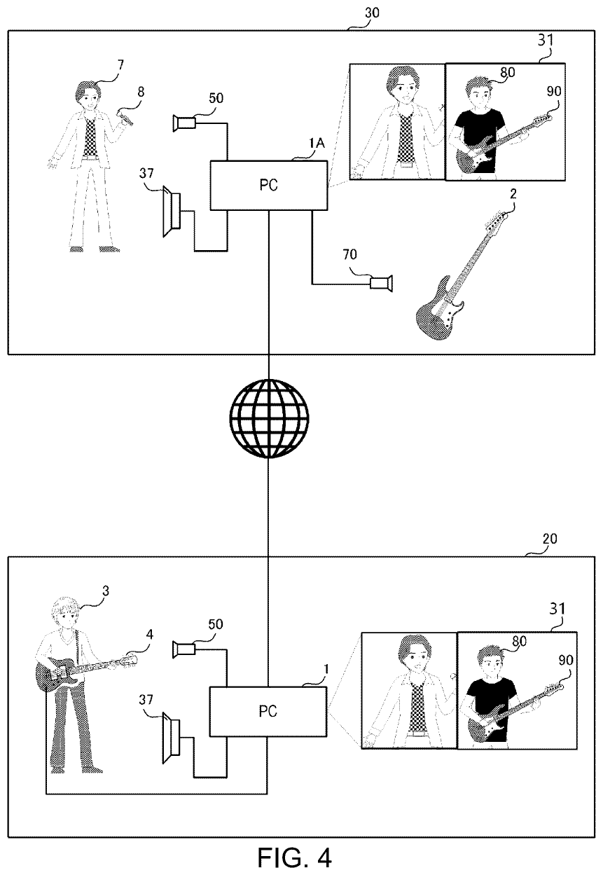

FIG. 4 is a configuration diagram of a performance sound generation system according to a second modified example. The configurations that are the same as those in FIG. 1 have been assigned the same reference numerals and the descriptions thereof have been omitted.

In the performance sound generation system according to the second modified example, the PC 1 at the second location 20 and a PC 1A disposed at a third location 30 are connected to each other via a network. The configuration of the PC 1A is the same as the configuration of the PC 1 shown in FIG. 2.

A microphone 8, the camera 50, and the camera 70 are connected to the PC 1A. At the third location 30, a second performer 7 uses the microphone 8 to sing. The PC 1A transmits, to the PC 1, the sound signal relating to the singing sound received by the microphone 8. In addition, the PC 1A transmits, to the PC 1, an image signal of the second performer 7 received from the camera 50.

The PC 1 reproduces the sound signal relating to the singing sound of the second performer 7 received from the PC 1A. The PC 1 displays images relating to the 3D model data rendered in S13 of FIG. 3 (an image of the performer 80 and an image of the first instrument 2 included in the image information 90), and an image of the second performer 7 received from the PC 1A.

The PC 1 transmits, to the PC 1A, the performance operation information generated in S12 of FIG. 3. The PC 1A executes the operations shown in S13 and S14 of FIG. 3, based on the received performance operation information. The PC 1A displays images relating to the 3D model data rendered in S13 (an image of the performer 80 and an image of the first instrument 2 included in the image information 90), and an image of the second performer 7 received from the camera 50. In addition, the PC 1A reproduces the sound signal relating to the performance sound of the first instrument 2 generated in S14. Alternatively, the PC 1 can execute the operations shown in S13 and S14 of FIG. 3, and transmit to the PC 1A, via a network, the sound signal relating to the performance sound of the first instrument 2 and the images generated in S13 and S14. The PC 1A reproduces the sound signal and the images that have been received.

In this manner, the performance sound generation system according to the second modified example allows the first performer 3 at the second location 20 and the second performer 7 at the third location 30 to perform an ensemble remotely. In the performance sound generation system according to the second modified example, the first performer 3 can use their own second instrument 4 at home to play the first instrument 2 located at the third location 30, which is a studio, and perform an ensemble with the second performer 7 without leaving home.

### THIRD MODIFIED EXAMPLE

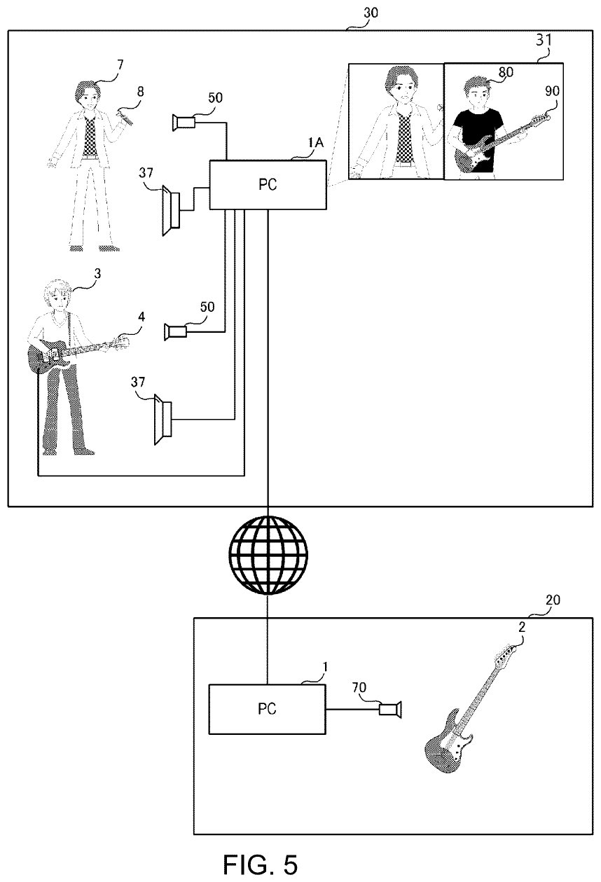

FIG. 5 is a configuration diagram of a performance sound generation system according to a third modified example. The configurations that are the same as those in FIG. 4 have been assigned the same reference numerals and their descriptions have been omitted.

In the performance sound generation system according to the third modified example, the first instrument 2 is an electric guitar in the possession of the first performer 3, and the second instrument 4 is an electric guitar located at the third location 30, which is a studio.

The camera 70 is connected to the PC 1. The microphone 8 and two cameras 50 are connected to the PC 1A.

The PC 1A executes the operations of S11 to S14 shown in FIG. 3. The PC 1A displays images relating to the 3D model data rendered in S13 (an image of the performer 80 and an image of the first instrument 2 included in the image information 90), and an image of the second performer 7 received from the cameras 50. In addition, the PC 1A reproduces the sound signal relating to the performance sound of the first instrument 2 generated in S14.

In the performance sound generation system according to the third modified example, the first performer 3 can use the second instrument 4 at the third location 30, which is a studio, to play the first instrument 2 located at the second location 20, which is home, to thereby perform an ensemble with the second performer 7. As a result, the first performer 3 can perform with the sounds of their own electric guitar anywhere, without having to carry their own electric guitar.

### FOURTH MODIFIED EXAMPLE

In the case of a musical instrument composed of a plurality of elements, the image information 90 and the acoustic information 91 can be provided for each element. For example, a saxophone has elements such as the main body, neck, mouthpiece, ligature, and reed. The image information 90 and the acoustic information 91 are provided for each of the elements, such as the main body, neck, mouthpiece, ligature, and reed.

In the operation of S13 in FIG. 3, the PC 1 renders an image of the saxophone based on a combination of a plurality of pieces of the image information 90. In addition, in the operation of S14 in FIG. 3, the performance sound is generated based on a combination of the plurality of pieces of the acoustic information 91.

The user can thereby perform after changing the external appearance and timbre by combining a plurality of elements that constitute the musical instrument.

### FIFTH MODIFIED EXAMPLE

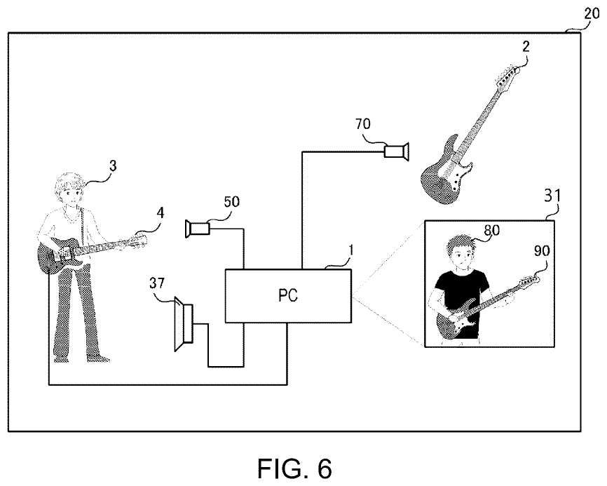

FIG. 6 is a configuration diagram of a performance sound generation system according to a fifth modified example. The configurations that are the same as those in FIG. 1 have been assigned the same reference numerals and the descriptions thereof have been omitted.

In the performance sound generation system according to the fifth modified example, the first instrument 2 is disposed at the second location 20. The camera 50 and the camera 70 are connected to the PC 1.

The PC 1 executes the operations of S11 to S14 shown in FIG. 3. The image information 90 and the acoustic information 91 can be stored in the flash memory 33 of the PC 1, or be stored in another device (for example, the server 100) and downloaded by the PC 1 each time.

In this case as well, the user can have a customer experience of being able to perceive as if the user is playing a favorite musical instrument (for example, the first instrument 2) other than the second instrument 4 that the user is actually touching.

### SIXTH MODIFIED EXAMPLE

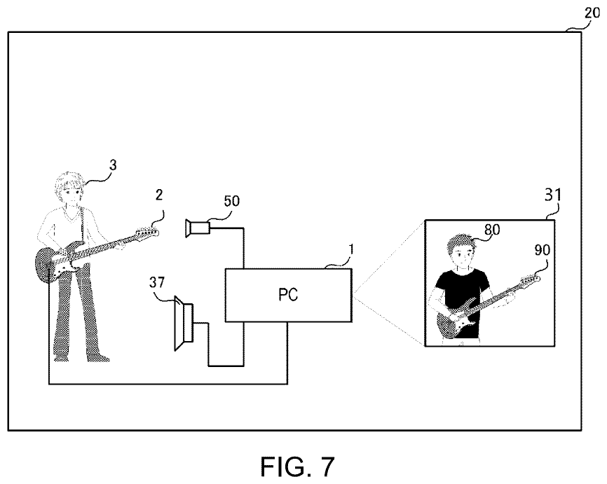

FIG. 7 is a configuration diagram of a performance sound generation system according to a sixth modified example. The configurations that are the same as those in FIG. 6 have been assigned the same reference numerals and their descriptions have been omitted.

In the performance sound generation system according to the sixth modified example, the first instrument 2 is disposed at the second location 20. The first performer 3 plays the first instrument 2. The first instrument 2 and the camera 50 are connected to the PC 1.

The PC 1 executes the operations of S11 to S14 shown in FIG. 3. The image information 90 and the acoustic information 91 can be stored in the flash memory 33 of the PC 1, or be stored in another device (for example, the server 100) and downloaded by the PC 1 each time.

In the sixth modified example, the first performer 3 plays the first instrument 2, and the PC 1 renders an image of the first instrument 2 and the 3D model data of the performer 80. In addition, the first performer 3 plays the first instrument 2, and the PC 1 generates the performance sound of the first instrument 2 based on the acoustic information 91.

The user can thereby have a novel customer experience of being able to perceive as if the user is playing a musical instrument in any environment. For example, the PC 1 can acquire the acoustic information 91 that models the sound of the first instrument 2 when the instrument is new, to generate the performance sound of the first instrument 2 as the instrument sounded when new. The user can thereby produce performance sounds of the first instrument 2 as the instrument sounded when new. Conversely, for example, the PC 1 can acquire acoustic information 91 that models the sound of the first instrument 2 from the past, to generate performance sounds of the past (vintage sounds), even with a brand new first instrument 2.

In addition, when information relating to acoustics is included in the acoustic information 91, the PC 1 can display, on the display unit 31, an image of a virtual concert hall, or the like, and carry out processing to reproduce the acoustics of the reproduction environment of the concert hall, or the like. The user can thereby have a novel customer experience of being able to perceive as if the user were performing live at a dream live music venue or concert hall that no longer exists.

The description of the present embodiment is exemplary in all respects and should not be considered restrictive. The scope of this disclosure is indicated by the Claims section, not the embodiment described above. Furthermore, the scope of this disclosure includes the scope that is equivalent that of the Claims.

For example, this disclosure can be a performance sound generation method comprising acquiring image information of a first instrument and acoustic information of the first instrument, acquiring performance operation information of a user playing a second instrument, rendering an image of the first instrument based on the image information, and generating a performance sound of the first instrument based on the performance operation information and the acoustic information.

In this case as well, it is possible to play the second instrument located at home, etc., and reproduce the sound of the first instrument located remotely, such as at a musical instrument store. Accordingly, the user can play a favorite musical instrument even from a remote location.

As shown in FIG. 6 or 7, a network configuration is not essential to this disclosure. The image information 90 and the acoustic information 91 do not need to be acquired via a network.

### EFFECTS OF THIS DISCLOSURE

According to one embodiment of this disclosure, the user can perceive as if the user is playing a musical instrument in any environment.

What is claimed is:

1. A performance sound generation method, the method comprising:
acquiring image information of a first instrument and acoustic information of the first instrument, the acoustic information changing in accordance with an environment change of the first instrument;
acquiring performance operation information of a user;
rendering an image of the first instrument based on the image information; and
generating a performance sound of the first instrument based on the performance operation information and the acoustic information.

2. The performance sound generation method according to claim 1, wherein
the performance operation information is acquired through a performance operation of the user on a second instrument.

3. The performance sound generation method according to claim 2, wherein
the image information or the acoustic information changes over time.

4. The performance sound generation method according to claim 2, further comprising
transmitting the performance sound of the first instrument via a network, to an information processing device used by the user,
receiving, at the information processing device, the performance sound of the first instrument via the network, and
reproducing the performance sound of the first instrument in accordance with the performance operation of the user on the second instrument.

5. The performance sound generation method according to claim 1, further comprising
acquiring information relating to a reproduction environment, and
applying signal processing to the performance sound of the first instrument based on the information relating to the reproduction environment.

6. The performance sound generation method according to claim 1, wherein
the image information of the first instrument and the acoustic information of the first instrument are acquired via a network.

7. The performance sound generation method according to claim 1, further comprising
reproducing the performance sound of the first instrument.

8. The performance sound generation method according to claim 1, further comprising
recording a non-fungible token corresponding to the image information and the acoustic information.

9. The performance sound generation method according to claim 8, further comprising
authenticating, with the non-fungible token, the image information of the first instrument and the acoustic information of the first instrument, and
providing the image information of the first instrument and the acoustic information of the first instrument which have been authenticated.

10. A performance sound generation device comprises:
a processor configured to
acquire image information of a first instrument and acoustic information of the first instrument, the acoustic information changing in accordance with an environment change of the first instrument,
acquire performance operation information of a user,
render an image of the first instrument based on the image information, and
generate a performance sound of the first instrument based on the performance operation information and the acoustic information.

11. The performance sound generation device according to claim 10, wherein
the processor is configured to acquire the performance operation information through a performance operation of the user on a second instrument.

12. The performance sound generation device according to claim 11, wherein
the acoustic information changes over time.

13. The performance sound generation device according to claim 10, wherein
the image information includes 3D model data.

14. The performance sound generation device according to claim 10, wherein
the processor is configured to acquire the image information that is acquired by a sensor.

15. The performance sound generation device according to claim 10, wherein
the processor is configured to acquire the performance operation information that is acquired by a sensor.

16. The performance sound generation device according to claim 10, wherein
the processor is further configured to record a non-fungible token corresponding to the image information and the acoustic information.

17. A non-transitory computer-readable storage medium storing a program executable by a processor of an information processing device to perform a performance sound generation method, the performance sound generation method comprising:
acquiring image information of a first instrument and acoustic information of the first instrument, the acoustic information changing in accordance with an environment change of the first instrument;
acquiring performance operation information of a user;
rendering an image of the first instrument based on the image information; and
generating a performance sound of the first instrument based on the performance operation information and the acoustic information.
